(19) United States
(12) Patent Application Publication
(10) Pub. No.: US 2015/0310405 A1
(43) Pub. Date: Oct. 29, 2015

(54) VELOCITY ACCELERATOR SYSTEM AND METHOD

(71) Applicant: Pollen Capital Ltd, Surbiton (GB)

(72) Inventors: Thomas Joseph COHEN, Kent (GB); Liam James HOUGHTON, Warwickshire (GB)

(73) Assignee: Pollen Capital Ltd, Surbiton (GB)

(21) Appl. No.: 14/263,294

(22) Filed: Apr. 28, 2014

(51) Int. Cl. G06Q 20/12; G06Q 30/02; G06Q 30/06

(52) U.S. Cl. CPC G06Q 20/123; G06Q 30/0601; G06Q 30/0273

(57) ABSTRACT

A velocity accelerator system increases a velocity of capital when developing, marketing and selling products. The system includes a user acceptance module for receiving parameters describing a system user, and for analyzing the parameters to determine whether or not the system user is acceptable to the system; a sales monitoring module for monitoring and/or facilitating sales of products from the system user, accepted by the system, to customers of the system; and a sales buffering module for receiving payment associated with the sales of the products, and for providing to the system user, accepted by the system, payments which are at least one of: temporally in advance of receipt of payment by the system of documented sale of the products to the customers, at temporal intervals which are more frequent than receipt of payment by the system of documented sale of the products to the customers.

### TECHNICAL FIELD

The present disclosure relates to velocity accelerator systems, for example to velocity accelerator systems for increasing a velocity of finance associated with products which have a relatively rapid growth pattern. Moreover, the present disclosure also relates to methods of using aforementioned velocity accelerator systems for promoting business growth and product sales. Furthermore, the present disclosure also relates to software products recorded on non-transitory (non-transient) machine-readable data storage media, wherein the software products are executable upon computing hardware for implementing aforementioned methods.

### BACKGROUND

Many contemporary products have a short development time, and are thereafter susceptible to a relatively short product-relevance lifetime, before they are superseded by more technically advanced products and/or consumer tastes change. Software products fall into the aforementioned contemporary products, especially software applications (“Apps”) which are readily downloadable via wireless communication to mobile communication devices including in-built computing hardware capable of executing such software applications.

Thus, new generations of mobile phones, for example those compatible with contemporary 3G or 4G wireless communication networks, have lead to explosive growth in “Apps” for those phones. Mobile phone manufacturers now offer application stores, or app stores, where a customer can purchase apps for their phones. App stores, however, are usually distinct from the associated telecoms, or telecommunication system operators, and telecoms have not been able to benefit greatly from this separate arrangement.

In a published United States patent application US2012/278175A1, (IBM Corp., USA, published 1 Nov. 2012, “Methods and arrangements of monetizing telecom app-stores through API usage”), there are described methods and arrangements for monetizing telecom applications. In the methods, advertising input is accepted, as well as contractual input relating to advertisement dissemination. An advertisement is associated with a telecom customer based on matchmaking criteria, and the advertisement is output to one or more customers based on the contractual input. Outputting of the advertisement includes propagating the advertisement selectively via at least one of: an in-application channel, wherein the advertisement is associated with a telecom application used by the one or more customers; and an out-of-application channel, wherein the advertisement is propagated directly to the customer.

However, despite the aforesaid methods and systems, it is generally difficult for developers of software applications, namely “Apps”, to finance development of their software applications, and receive income therefrom promptly when they are downloaded by one or more customers from an app store wherefrom the software applications are made available to one or more customers. However, such considerations pertain mutatis mutandis to other types of contemporary technical products, and not just to software applications.

### SUMMARY

The present invention seeks to provide a velocity accelerator system and a method of using the same.

Moreover, the present invention seeks to provide a software product recorded on non-transitory machine-readable data storage media, where the software product is executable upon computing hardware for implementing the method of using the velocity accelerator system.

According to a first aspect, there is provided a velocity accelerator system for increasing a velocity of capital when developing, marketing and selling one or more products. The system includes a user acceptance module for receiving one or more parameters describing at least one system user, and for analyzing the one or more parameters to determine whether or not the at least one system user is acceptable to the system; a sales monitoring module for monitoring and/or facilitating sales of one or more products from the at least one system user, accepted by the system, to one or more customers of the system; and a sales buffering module for receiving payment associated with the sales of the one or more products, and for providing to the at least one system user, accepted by the system, payments which are at least one of: temporally in advance of receipt of payment by the system of documented sale of the one or more products to the one more customers, at temporal intervals which are more frequent than receipt of payment by the system of documented sale of the one or more products to the one more customers.

In accordance with an embodiment of the present disclosure, the sales buffering module is configurable to divide a portion of the received payments to the at least one system user, accepted by the system, and another portion of the received payments to one or more advertising promotions for promoting sales of the one or more products via an advertising module of the system.

In accordance with an embodiment of the present disclosure, the one or more products include one or more software applications (Apps) downloadable from a software application store (app store) to the one or more customers.

In accordance with an embodiment of the present disclosure, for receiving payment associated with the sales of the one or more products, the sales buffering module is operable to retain a portion of the payment for retention of one or more operators of the velocity accelerator system, to finance operation of the velocity accelerator system.

In accordance with an embodiment of the present disclosure, the advertising module is operable to direct advertisements for the one or more products based upon at least one of: monitoring markets into which the one or more products are being sold, an analysis of potential markets in which the one or more products are susceptible to being sold based on parameters describing one or more characteristics of the one or more products.

According to a second aspect, there is provided a method of using a velocity accelerator system for increasing a velocity of capital when developing, marketing and selling one or more products. The method includes, using a user acceptance module to receive one or more parameters describing at least one system user, and to analyze the one or more parameters to determine whether or not the at least one system user is acceptable to the system; using a sales monitoring module to monitor and/or facilitate sales of one or more products from the at least one system user, accepted by the system, to one or more customers of the system; and using a sales buffering module to receive payment associated with the sales of the one or more products, and to provide to the at least one system user, accepted by the system, payments which are at least one of: temporally in advance of receipt of payment by the system of documented sale of the one or more products to the one more customers, at temporal intervals which are more frequent than receipt of payment by the system of documented sale of the one or more products to the one more customers.

In accordance with an embodiment of the present disclosure, the method includes configuring the sales buffering module to divide a portion of the received payments to the at least one system user, accepted by the system, and another portion of the received payments to one or more advertising promotions for promoting sales of the one or more products via an advertising module of the system.

According to a third aspect, there is provided a software product recorded on non-transitory machine-readable data storage media, wherein the software product is executable upon computing hardware for implementing the method of using the velocity accelerator system.

The invention is of advantage in that the velocity accelerator system facilitates the developers of software applications to receive revenues promptly when their Apps are downloaded by one or more customers from an app store. The velocity accelerator system accelerates and potentially multiplies online merchant's payments to the product developers, and is clearly linked to early access to revenues, which, in turn, is linked to early advertisement. The velocity accelerator system optimizes the revenue generation by financing early revenue collection and re-directing it to advertising. Early re-investment effectively enables a larger marketing budget, which is transformed into larger revenues.

It will be appreciated that features of the invention are susceptible to being combined in various combinations without departing from the scope of the invention as defined by the appended claims.

### DESCRIPTION OF THE DIAGRAMS

Embodiments of the present invention will now be described, by way of example only, with reference to the following diagrams wherein:

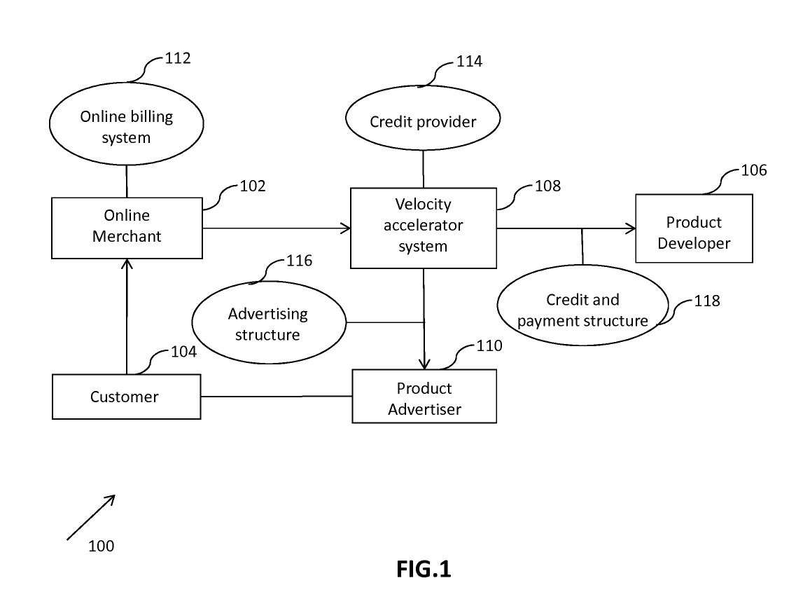

FIG. 1 is an illustration of an environment, wherein various embodiments of the present invention can be practiced;

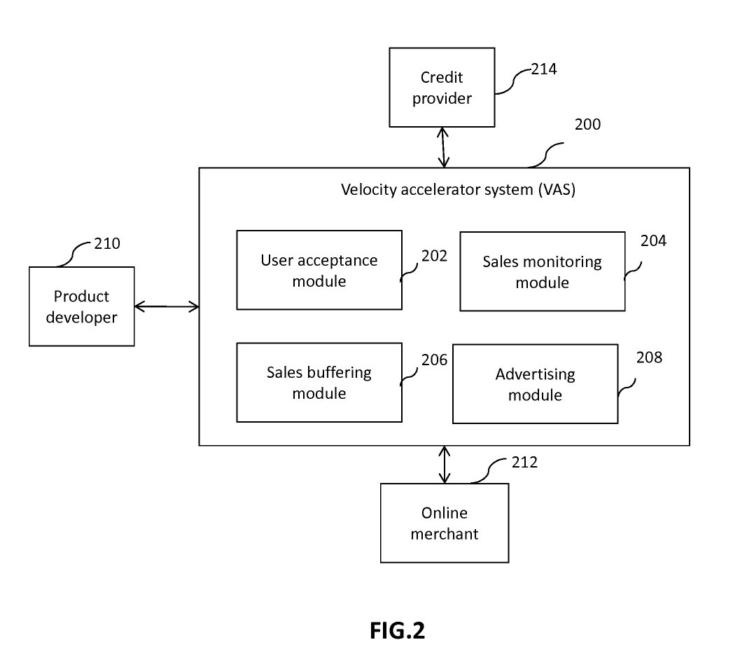

FIG. 2 is an illustration of a velocity accelerator system of FIG. 1, in accordance with the present disclosure;

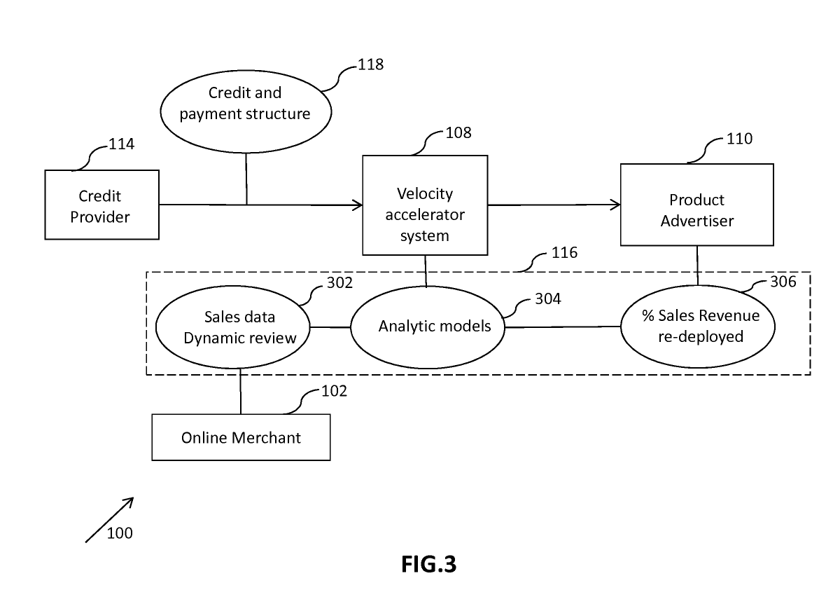

FIG. 3 is a detailed illustration of an advertising structure of FIG. 1, in accordance with the present disclosure;

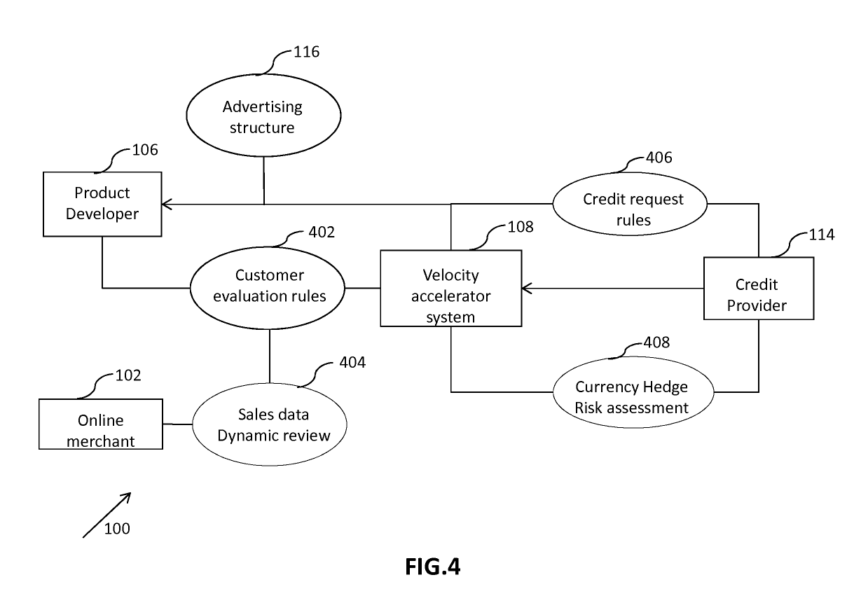

FIG. 4 is a detailed illustration of a credit and payment structure of FIG. 1, in accordance with the present disclosure; and

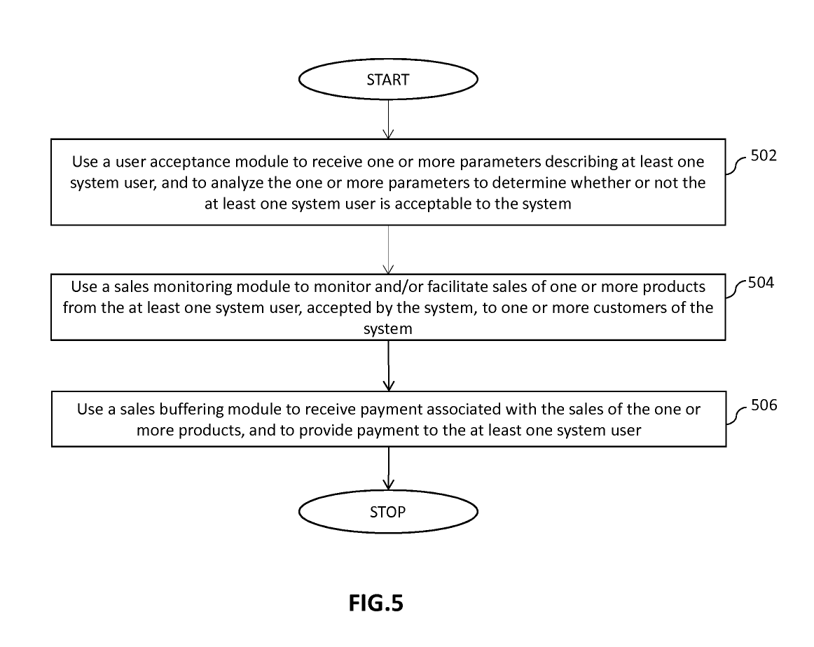

FIG. 5 is an illustration of steps of a method of using the velocity accelerator system, in accordance with the present disclosure.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

Referring to FIG. 1, there is provided an environment 100, wherein various embodiments of the present disclosure can be practiced. The environment 100 includes an online merchant 102, a customer 104, a product developer 106, a velocity acceleration system (VAS) 108, a product advertiser 110, an online billing system 112, a credit provider 114, an advertising structure 116, and a credit and payment structure 118.

The online merchant 102 generally includes an online seller that enables the customer 104 to purchase one or more products online using at least one of: a mobile phone, a personal digital assistant, a tablet, a phablet, a webpad, a wearable computer, a mobile telephone, a wrist-worn computer, and a smart phone. Examples of the products include, but are not limited to, goods, services and software applications (Apps) downloadable from a software application store (app store), where the app store is an example of the online merchant 102; the goods optionally including items of clothing, for example fashion clothing which potentially is subject to rapid changes in clothes fashions. The online merchant 102 employs the online billing system 112 to enable the customer 104 to pay for the purchased products using at least one of: credit card, debit card, Internet banking account, mobile banking, PayPal and Google checkout, “Google” and “Paypal” are registered trademarks.

The product developer 106 develops the products, such as software Apps and sells them to the customer 104 through the online merchant 102. In an example, the customer 104 purchases an app from an online merchant 102 such as an app store. Thereafter, the product developer 106 receives the requisite payment in respect of the sale of the product from the VAS 108, instead of the online merchant 102. The VAS 108 pays the product developer 106 by way of the credit and payment structure 118, before release of funds from the online merchant 102, thereby enabling the product developer 106 to receive funds early and optionally deploy them for advertising and/or product development. The VAS 108 receives funds for early payout to the product developer 106 from the credit provider 114, and later on, it is paid directly by the online merchant 102, to settle with the credit provider 114 according to a separate contract.

In an embodiment of the present disclosure, the VAS 108 pays a portion of payment associated with the sale of the product, to the product developer 106, and deploys remaining payment in promoting sales of the products, through the product advertiser 110 by way of the advertising structure 116. Examples of the product advertiser 110, include, but are not limited to, mobile advertising, native advertising with mobile (software) applications, website advertising, advertisement placement websites, such as Facebook; “Facebook” is a registered trademark. Thus, the VAS 108 increases the velocity of capital when developing, marketing and selling one or more products of the product developer 106.

FIG. 2 is a schematic illustration of the VAS 200, which is an example of the velocity acceleration system 108, in accordance with the present disclosure. The VAS 200 includes a user acceptance module 202, a sales monitoring module 204, a sales buffering module 206, and an advertising module 208.

The user acceptance module 202 is configured to receive parameters of a system user such as a product developer 210, and analyze those parameters to determine whether or not the product developer 210 is eligible to register with the VAS 200 and receive early payouts in respect of corresponding products sold by the online merchant 212. In an embodiment of the present disclosure, the product developer 210 sends a request to the user acceptance module 202 for registering therein. Thereafter, the user acceptance module 202 performs a user check and evaluation based on certain predefined user acceptance rules, for example, the user acceptance module 202 checks a credit history of the product developer 210, determines whether he/she is a genuine product developer, and whether past sales of his/her products equals to or exceeds a set threshold value. Based on the evaluation, the user acceptance module 202 may rank a given product developer 210, and based on the rank, allow the product developer 210 to register with the VAS 200. After the product developer 210 registers with the VAS 200, the VAS 200 is granted read/write access to developer's account with the online merchant 212. The product developer's 210 account with the online merchant 212 includes information regarding corresponding products sold by the online merchant 212.

The sales monitoring module 204 is configured to monitor and/or to facilitate sales of products of the product developer 210. In an embodiment of the present disclosure, the products are sold indirectly from the product developer 210 to a customer through the online merchant 212, and as soon as a product is sold, it is updated immediately in the product developer's 210 account with the online merchant 212. The sales monitoring module 204 continuously or periodically monitors the product developer's account with the online merchant 212, and facilitates early payouts in respect of products thus sold. In certain situations the data itself is, for example, a day old and the analysis is then performed when the data is made available.

The sales buffering module 206 is configured to receive payment associated with the sale of a product from a credit provider, for example, a credit provider 214, and pay the product developer 210 accordingly, where the payments to the product developer 210 are at least one of: temporally in advance of receipt of payment from the online merchant 212, and, at temporal intervals which are more frequent than receipt of payment from the online merchant 212. In an example, the sales buffering module 206 receives the payment from the online merchant 212 approximately within a period of 40 to 60 days of sale of the product, however, pays in advance to the product developer 210, approximately within a period of 1 to 7 days of sale of the product.

In an embodiment of the present disclosure, the sales buffering module 206 is configurable to pay a portion of the payments received from the credit provider 214 to the product developer 210, and pay another portion of the received payments to one or more advertising promotions for promoting sales of the products of the product developer 210 via the advertising module 208.

In another embodiment of the present disclosure, the sales buffering module 206 is operable to retain a portion of the payments associated with the sales of the product, for retention of operators of the VAS 200, to finance operation of the VAS 200.

The advertising module 208 is operable to direct advertisements for a product of the product developer 210, based upon at least one of: monitoring markets into which the product is being sold, an analysis of potential markets in which the product is susceptible to being sold based on parameters describing one or more characteristics of the product.

FIG. 3 is a detailed illustration of the advertising structure 116 of the environment 100, in accordance with the present disclosure. The advertising structure 116 includes one or more decision making models and rules, based on which the VAS 108 deploys funds for promoting sales of the products of the product developer 106. Such decision making models and rules include, but are not limited to, sales data dynamic review 302, analytic models 304, and percentage of sales revenue re-deployed 306.

The sales data dynamic review 302 includes dynamic reviews and examination of e-sales and advertising data, reviewing the product developer's 106 account with the online merchant 102, and ranking the product developer 106 based on the number of times the corresponding product sales have exceeded a set threshold value.

The analytic models 304 are either in-house analytic models or external analytic models such as App Annie Analytics; “App Annie Analytics” is a trademark. The App Annie analytics is a free sales analytics dashboard for app publishers, which allows publishers to track their app downloads, revenues, rankings and reviews across multiple platforms, and where the publishers can access data via a web dashboard, daily email reports, export function, and API. The in-house analytic models may be configured to automatically input various parameters such as sales receivables and revenues (verified receivables) in advertising for decision making of various aspects in the VAS 108.

The percentage of sales revenue re-deployed 306 is either fixed (for example, 80% of sales revenues) or a variable estimated based on analytical factors such as industry standard and industry average. In one embodiment of the present disclosure, percentage of sales revenue to be re-deployed for advertising are estimated based on a revenue redeployment model, which is speculated based on external analytics models such as App Annie analytics, and customer ranking from sales data dynamic review 302.

FIG. 4 is a detailed illustration of the credit and payment structure 118 of the environment 100, in accordance with the present disclosure. The credit and payment structure 118 includes one or more decision making models and rules, based on which the VAS 108 receives a credit from the credit provider 114 and does an early payout to the product developer 106. Such decision making models and rules include, but are not limited to, customer evaluation rules 402, sales data dynamic review 404, which is an example of the sales data dynamic review 302, credit request rules 406, and currency hedge risk assessment 408.

The customer evaluation rules 402 include various parameters used by the VAS 108 to determine whether or not a customer is suitable for registering with the VAS 108 for receiving an early pay-out. Such rules include, but are not limited to, periodic checks to check if bank information was not changed by the customer, credit history, past sales data and credibility of the customer.

The credit request rules 406 lay out various rules, credit amount, credit period, and various terms and conditions, between the credit provider 114 and the VAS 108. The currency hedge risk assessment 408 facilitates hedging the accruals that arise from currency conversions during transactions between the credit provider 114 and the VAS 108.

The VAS 108 accelerates and potentially multiplies online merchant's 102 payments to the product developers 106. The acceleration aspect of the concept is clearly linked to early access to revenues (7 days in contradistinction to up to 60 currently), which, in turn, is linked to early advertisement. The revenue increase from the early advertisement is linked to a technical solution such as an automated decision-making analytics model 304. The VAS 108 optimizes the revenue generation by financing early revenue collection and re-directing it to advertising. Early re-investment effectively enables a larger marketing budget, which is transformed into larger revenues. It can also be the basis for decreasing the cost of capital for developers seeking further investment with or without releasing more equity.

The concept is applicable to any business with a central billing system in which the VAS 108 can ingest/analyse data. The concept is applicable to industries with similar characteristics (e.g. payments via mobile networks). Essentially, the high level parameters are the existence of a central billing system for a digital product, typically with one or more high credit quality counterparties making payments to multiple suppliers/content providers.

One application area is Digital Advertising Market, in which publishers of Internet websites/mobile applications rely on payments from advertisers as a revenue stream. By interfacing directly into the ad server, the VAS 108 can make accelerated payouts to publishers who have generally to wait to collect the funds received from the ad network. The VAS 108 can also collaborate with the ad network to offer the service as an added-value-service to its publishers on a white label basis.

Another application area is eBook market, in which the VAS 108 can make accelerated payouts to eBook publishers/authors, who have generally to wait to collect funds from a marketplace such as AMAZON™; “Amazon™” is a registered trademark.

Yet another application area is Digital Music Market, in which the VAS 108 can make accelerated payouts to record labels/digital music distributors, who have to generally wait to collect funds from a marketplace such as APPLE™ and iTunes™; “Apple™” and “iTunes™” are registered trademarks.

FIG. 5 is an illustration of steps of a method of using the velocity accelerator system 100, in accordance with the present disclosure. The method is depicted as a collection of steps in a logical flow diagram, which represents a sequence of steps that can be implemented in hardware, software, or a combination thereof.

At a step 502, the user acceptance module is used to receive one or more parameters describing at least one system user, and to analyze the one or more parameters to determine whether or not the at least one system user is acceptable to the system.

At a step 504, the sales monitoring module is used to monitor and/or facilitate sales of one or more products from the at least one system user, accepted by the system, to one or more customers of the system.

At a step 506, a sales buffering module is used to receive payment associated with the sales of the one or more products, and to provide to the at least one system user, accepted by the system, payments which are at least one of: temporally in advance of receipt of payment by the system of documented sale of the one or more products to the one more customers, at temporal intervals which are more frequent than receipt of payment by the system of documented sale of the one or more products to the one more customers.

It should be noted here that the steps 502 to 506 are only illustrative and other alternatives can also be provided where one or more steps are added, one or more steps are removed, or one or more steps are provided in a different sequence without departing from the scope of the claims herein.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

We claim:

1. A velocity accelerator system for increasing a velocity of capital when developing, marketing and selling one or more products, wherein the system includes:
(i) a user acceptance module for receiving one or more parameters describing at least one system user, and for analyzing the one or more parameters to determine whether or not the at least one system user is acceptable to the system;
(ii) a sales monitoring module for monitoring and/or facilitating sales of one or more products from the at least one system user, accepted by the system, to one or more customers of the system; and
(iii) a sales buffering module for receiving payment associated with the sales of the one or more products, and for providing to the at least one system user, accepted by the system, payments which are at least one of: temporally in advance of receipt of payment by the system of documented sale of the one or more products to the one more customers, at temporal intervals which are more frequent than receipt of payment by the system of documented sale of the one or more products to the one more customers.

2. The velocity accelerator system of claim 1, wherein the sales buffering module is configurable to divide a portion of the received payments to the at least one system user, accepted by the system, and another portion of the received payments to one or more advertising promotions for promoting sales of the one or more products via an advertising module of the system.

3. The velocity accelerator system of claim 1, wherein the one or more products include one or more software applications (Apps) downloadable from a software application store (app store) to the one or more customers.

4. The velocity accelerator system of claim 1, wherein the sales buffering module, for receiving payment associated with the sales of the one or more products, is operable to retain a portion of the payment for retention of one or more operators of the velocity accelerator system, to finance operation of the velocity accelerator system.

5. The velocity accelerator system of claim 2, wherein the advertising module is operable to direct advertisements for the one or more products based upon at least one of: monitoring markets into which the one or more products are being sold, an analysis of potential markets in which the one or more products are susceptible to being sold based on parameters describing one or more characteristics of the one or more products.

6. A method of using a velocity accelerator system for increasing a velocity of capital when developing, marketing and selling one or more products, wherein the method includes:
(i) using a user acceptance module to receive one or more parameters describing at least one system user, and to analyze the one or more parameters to determine whether or not the at least one system user is acceptable to the system;
(ii) using a sales monitoring module to monitor and/or facilitate sales of one or more products from the at least one system user, accepted by the system, to one or more customers of the system; and
(iii) using a sales buffering module to receive payment associated with the sales of the one or more products, and to provide to the at least one system user, accepted by the system, payments which are at least one of: temporally in advance of receipt of payment by the system of documented sale of the one or more products to the one more customers, at temporal intervals which are more frequent than receipt of payment by the system of documented sale of the one or more products to the one more customers.

7. The method of claim 6, wherein the method includes configuring the sales buffering module to divide a portion of the received payments to the at least one system user, accepted by the system, and another portion of the received payments to one or more advertising promotions for promoting sales of the one or more products via an advertising module of the system.

8. The method of claim 6, wherein the one or more products include one or more software applications (Apps) downloadable from a software application store (app store) to the one or more customers.

9. The method of claim 6, wherein the sales buffering module, for receiving payment associated with the sales of the one or more products, is operable to retain a portion of the payment for retention of one or more operators of the velocity accelerator system, to finance operation of the velocity accelerator system.

10. The method of claim 7, wherein the advertising module is operable to direct advertisements for the one or more products based upon at least one of: monitoring markets into which the one or more products are being sold, an analysis of potential markets in which the one or more products are susceptible to being sold based on parameters describing one or more characteristics of the one or more products.

11. A software product recorded on non-transitory machine-readable data storage media, wherein the software product is executable upon computing hardware for implementing the method of claim 6.
